(19) United States
(12) Patent Application Publication
(10) Pub. No.: US 2006/0080319 A1
(43) Pub. Date: Apr. 13, 2006

(54) Apparatus, system, and method for facilitating storage management

(76) Inventors: John Edward Hickman, Salinas, CA (US); Kesavaprasath Ranganathan, Poughkeepsie, NY (US); Michael Anthony Schmidt, Stone Ridge, NY (US); Steven Richard Van Gundy, Gilroy, CA (US)

Correspondence Address: KUNZLER & ASSOCIATES, 8 EAST BROADWAY, SUITE 600, SALT LAKE CITY, UT, 84111, US

(21) Appl. No.: 10/963,086

(22) Filed: Oct. 12, 2004

(51) Int. Cl. G06F 17/30

(52) U.S. Cl. 707/10

(57) ABSTRACT

An apparatus, system, and method are provided for facilitating storage management through organization of storage resources. The present invention includes a configuration module that configures a first logical entity and a second logical entity to interact with each other in a peer-to-peer domain such that each logical entity mirrors operations of, and is in direct communication with, the other logical entity. An information module exposes local resources of the first logical entity and local resources of the second logical entity to a management node such that the local resources are available as target resources of a management command from the management node. An address module selectively addresses a management command from the management node towards a local resource of the first logical entity and/or a local resource of the second logical entity as determined by the type of management command.

### BACKGROUND OF THE INVENTION

1. Field of the Invention

The invention relates to data storage computer systems. Specifically, the invention relates to apparatus, systems, and methods for facilitating storage management through organization of storage resources.

2. Description of the Related Art

Computer and information technology continues to progress and grow in its capabilities and complexity. In particular, data storage systems continue to evolve to meet the increasing demands for reliability, availability, and serviceability of the physical data storage system and its hardware, software, and various other components. Data storage systems often handle mission critical data. Consequently, data storage systems are expected to remain on-line and available according to a 24/7 schedule. Furthermore, data storage systems are expected to handle power and service outages, hardware and software failures, and even routine system maintenance without significantly compromising the reliability and availability to handle data Input/Output (I/O) from hosts.

FIG. 1 illustrates a conventional data storage system 100. The system 100 includes one or more hosts 102 connected to a storage subsystem 104 by a network 106 such as a Storage Area Network (SAN) 106. The host 102 communicates data I/O to the storage subsystem 104. Hosts 102 are well known in the art and comprise any computer system configured to communicate data I/O to the storage subsystem 104.

One example of a storage subsystem 104 suitable for use with the present invention is an IBM Enterprise Storage Server® available from International Business Machines Corporation (IBM) of Armonk, N.Y. To provide reliability, availability, and redundancy, the storage subsystem 104 includes a plurality of host adapters (not shown) that connect to the SAN 106 over separate channels. The host adapters 108 may support high speed communication protocols such as Fibre Channel. Of course, various other host adapters 108 may be used to support other protocols including, but not limited to, Internet Small Computer Interface (iSCSI), Fibre Channel over IP (FCIP), Enterprise Systems Connection (ESCON), InfiniBand, and Ethernet. The storage subsystem 104 stores and retrieves data using one or more mass storage devices 108 such as, but not limited to Direct Access Storage Devices, tape storage devices, and the like.

As hardware costs have gone down, data storage systems 100 have become more complex due to inclusion of redundant hardware and hardware subsystems. Often, the hardware components are susceptible to failure. Consequently, the storage subsystem 104 may include one or more processors, electronic memory devices, host adapters, and the like.

Typically, to make most productive use of the redundant hardware, the hardware is specifically allocated or shared between a plurality of logical nodes 110. A logical node 110 represents an allocation of the computing hardware resources of the storage subsystem 104 such that each logical node 110 is capable of executing an Operating System (OS) 112 independent of another logical node 110. In addition, each logical node 110 operates an independent set of applications 114. The logical nodes 110 appear as separate physical computing systems to the host 102.

A coordination module 116, also known as a Hypervisor (PHYP) 116, coordinates use of dedicated and shared hardware resources between two or more defined logical nodes 110. The PHYP 116 may be implemented in firmware on a dedicated processor. Typically, the logical nodes 110 share memory. The PHYP 116 may ensure that logical nodes 110 do not access inappropriate sections of memory.

Separating the storage subsystem 104 into a plurality of logical nodes 110 allows for higher reliability. If one logical node 110 crashes/fails due to a software or hardware problem. One or more other logical nodes 110 may be used to continue or restart the tasks that were being performed by the crashed logical node 110.

Management, control, and servicing of the plurality of logical nodes 110 is a challenge. Any management, control, maintenance, monitoring, troubleshooting or service operation should be coordinated with the constant I/O processing so that the 24/7 availability of the storage subsystem 104 is not compromised. Typically, a management console 118 manages the storage subsystem 104 via control communications (referred to herein as “out-of-band communication”) that are separate from the I/O channels.

The storage subsystem 104 may include a network adapter, such as an Ethernet card, for out-of-band communications. The management console 118 may comprise a separate computer system such as a workstation executing a separate OS and set of management applications. The management console 118 allows an administrator to interface with the PHYP 116 to start (create), stop, and configure logical nodes 110.

Unfortunately, the management capabilities of the management console 118 are severely limited. In particular, the logical nodes 110 are completely independent and unrelated. Consequently, to manage a plurality of logical nodes 110, for example to set a storage space quota, an administrator must login to each node 110 separately, make the change, and then log out. This process is very tedious and can lead to errors as the number of logical nodes 110 involved in the operation increases. Currently, there is no way to manage two or more logical nodes 110 simultaneously. The nodes 110 are managed sequentially, one at a time.

Due to the reliability and availability benefits, it is desirable to associated two or more logical nodes 110 such that each node 110 actively mirrors all operations of the other. In this manner, if one node 110 fails/crashes the other node can take over and continue servicing I/O requests. It is also desirable to manage associated logical nodes 110 together as a single entity or individually as needed from a single management node. However, currently there is no relationship between logical nodes 110 and no way to simultaneously manage more than one logical node 110 at a time.

The repetitive nature of management and service changes are exacerbated in a storage subsystem 104 where nodes 110 may be highly uniform and may differ in configuration by an attribute as minor as a name. A storage facility may also wish to apply various combinations of policies, attributes, or constraints on one or more commonly configured nodes 110. Currently, to do so an administrator has to separately track the similarities and differences between the nodes 110 such that policies can be implemented and maintained. Any policies that apply to subsets of the nodes 110 are difficult and time consuming to implement and maintain.

Even if nodes 110 were related, the administrator must login to each node 110 separately and may have to physically move to a different management console 118 machine to complete the management operations. The related nodes 110 may provide redundant I/O operation. But, management of the related nodes 110 is challenging and time consuming. The high number of nodes 110 that must each be individually managed limits the administrator's effectiveness.

From the foregoing discussion, it should be apparent that a need exists for an apparatus, system, and method for facilitating storage management. Beneficially, such an apparatus, system, and method would automatically manage two or more related nodes 110 as a single entity or individually as needed. Similarly, the apparatus, system, and method would support management of groups of related nodes 110 such that security is maintained between the groups but different policies can be readily implemented and maintained. Furthermore, the apparatus, system, and method would support management of a plurality of hardware platforms, such as for example a storage subsystems 104, for different groupings of nodes 110. The apparatus, system, and method would allow for redundant management nodes to actively manage a plurality of related and/or unrelated nodes 110.

### SUMMARY OF THE INVENTION

The present invention has been developed in response to the present state of the art, and in particular, in response to the problems and needs in the art that have not yet been met to facilitate management of logical nodes through a single management module. Accordingly, the present invention has been developed to provide an apparatus, system, and method to facilitate management of logical nodes through a single management module that overcomes many or all of the above-discussed shortcomings in the art.

An apparatus according to the present invention includes a configuration module, an information module, and an address module. The configuration module configures a first logical entity and a second logical entity to interact with each other in a peer-to-peer domain such that each logical entity mirrors operations of, and is in direct communication with, the other logical entity.

The peer-to-peer domain may include two or more logical entities related such that I/O and management operations performed by one entity are automatically performed by the other entity. The two or more logical entities may be related to provide redundancy of hardware dedicated to each of the logical entities. Logical entities may correspond to logical nodes, virtual machines, Logical Partitions (LPARS), Storage Facility Images (SFIs), Storage Application Images (SAIs), and the like. Logical entities of a peer-to-peer domain may each include substantially equal rights to monitor and manage each other. In one embodiment, a first logical entity and a second logical entity in a peer-to-peer domain are configured to take over operations of the other logical entity in response to failure of one of the logical entities. The operational logical entity may log a set of changes since the failed logical entity went offline and restore the set of changes in response to the failed logical entity coming online.

The information module exposes local resources of the first logical entity and local resources of the second logical entity to a management node. The local resources are exposed such that the local resources of the first logical entity and the second logical entity are available as target resources of a management command from the management node. The information module may broadcast the local resources of the first logical entity and local resources of the second logical entity to the management node. Alternatively, the information module may register the local resources of the first logical entity and local resources of the second logical entity in a central repository accessible to the management node.

The management node may be in a management relationship with the first logical entity and second logical entity. The management relationship defines a management domain permitting the management node to manage and monitor the logical entities. The logical entities, however, are incapable of managing or monitoring the management node.

In certain embodiments, the management domain comprises a first set of logical entities in a peer-to-peer domain with each other and a second set of logical entities in a peer-to-peer domain with each other. The local resources of each logical entity may be exposed to the management node for use as target resources of a management command. Furthermore, the logical entities of each set may be unable to communicate with logical entities of the other set. Management commands may be targeted to both sets, one set, or individual logical entities of either or both sets.

In another embodiment, the management domain comprises a second management node configured to interact with the management node in a management peer-to-peer domain. The management peer-to-peer domain allows either management node to monitor and take over management operations in response to a failure of one of the management nodes.

In certain embodiments, a synchronization module synchronizes resource definitions representative of the local resources of the first logical entity and the second logical entity in response to modifications made to the local resources by the first logical entity or the second logical entity.

The first logical entity and second logical entity may comprise Logical Partitions (LPARS) of a common hardware platform. The LPARS may be configured such that each LPAR executes on a separate Central Electronics Complex (CEC) of the common hardware platform. The first logical entity and second logical entity may define an independently manageable Storage Facility Image (SFI). The management module may be configured to send the management command to a plurality of SFIs within a management domain. Alternatively, or in addition, the pair of logical entities are defined in an independently manageable Storage Application Image (SAI).

A signal bearing medium of the present invention is also presented including machine-readable instructions configured perform operations to facilitate storage management through organization of storage resources. In one embodiment, the operations include an operation to configure a first logical entity and a second logical entity to interact with each other in a peer-to-peer domain such that each logical entity mirrors operations of, and is in direct communication with, the other logical entity. Another operation exposes local resources of the first logical entity and local resources of the second logical entity to a management node such that the local resources of the first logical entity and the second logical entity are available as target resources of a management command from the management node. Finally, an operation is executed to selectively address a management command from the management node towards a local resource of the first logical entity and a local resource of the second logical entity.

The present invention also includes embodiments arranged as a system, method, and an apparatus that comprise substantially the same functionality as the components and steps described above in relation to the apparatus and method. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating a conventional system of managing a plurality of unrelated, independent logical nodes;

FIG. 2 is a logical block diagram illustrating organization of entities to facilitate storage management through organization of storage resources in accordance with the present invention;

FIG. 3 is a logical block diagram illustrating one embodiment of an apparatus for facilitating storage management through organization of storage resources in accordance with the present invention;

FIG. 4 is a schematic block diagram illustrating a representative system suitable for implementing certain embodiments of the present invention;

FIG. 5 is a schematic block diagram illustrating a logical representation of entities utilizing the system components illustrated in FIG. 4 according to one embodiment of the present invention; and

FIG. 6 is a schematic flow chart diagram illustrating a method for facilitating storage management through organization of storage resources.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the apparatus, system, and method of the present invention, as presented in the Figures, is not intended to limit the scope of the invention, as claimed, but is merely representative of select embodiments of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

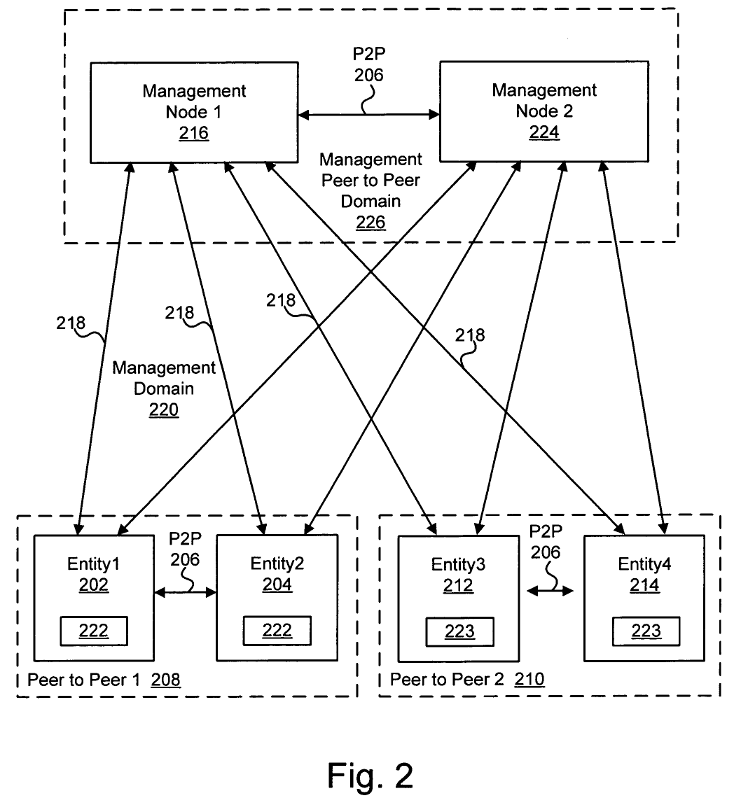

FIG. 2 illustrates a logical representation of a management structure 200 that facilitates storage management. In certain embodiments, a first logical entity 202 and a second logical entity 204 share a peer-to-peer relationship 206. As used herein, a “logical entity” refers to any logical construct for representing two or more things (logical or physical) that share a relationship. Accordingly, logical entities as used throughout this specification may comprise logical nodes, virtual machines, Logical Partitions (LPARS), Storage Facility Images (SFIs discussed in more detail below), Storage Application Images (SAIs discussed in more detail below), and the like.

A pair of logical entities 202, 204 related by a peer-to-peer relationship 206 is advantageous. In one embodiment, the logical entities 202, 204 may serve as storage entities defining a plurality of logical storage devices accessible to hosts 102. In other words, storage space on storage devices may be allocated to each logical device and configured to present logical storage devices for use by the hosts 102.

Preferably, the first logical entity 202 is configured substantially the same as the second logical entity 204. Each logical entity 202, 204 may actively service I/O communications such that if one entity 202, 204 fails, the other entity 202, 204 can continue to service further I/O communications without any disruption. The logical entities 202, 204 serve as “hot” (active) backups for each other. There is no delay in using one logical entity 202, 204 or the other when one logical entity fails 202, 204. Because it is desirable that failure of one logical entity 202, 204 is unnoticed by the host 102, the logical entities 202, 204 are configured with the same size, parameters, and other attributes.

Similarly configured logical entities 202, 204 should also be managed using the same commands such that entity 202, 204 remains synchronized in its configuration with the other entity 202, 204. The present invention organizes the logical entities 202, 204 into a peer-to-peer domain 208. A peer-to-peer domain 208 represents a logical grouping of one or more entities 202, 204. Each logical entity 202, 204 is in communication with the other logical entities 202, 204 such that operations performed on one entity 202, 204 are also automatically performed on the other entity 202, 204. A second peer-to-peer domain 210 may also be defined having a third logical entity 212 and a fourth logical entity 214 in a peer-to-peer relationship 206. Preferably, members of a first peer-to-peer domain 208 are prevented from communicating, monitoring, or controlling members of a second peer-to-peer domain 210, and vice versa. Reference is now made to the peer-to-peer domain 208 and logical entities 202, 204. Those of skill in the art will recognize that description may also be readily applied to the peer-to-peer domain 210 and third logical entity 212 and a fourth logical entity 214.

Preferably, the peer-to-peer domain 208 provides direct communication (no intermediaries) between the logical entities 202, 204 of the peer-to-peer domain 208. Of course, a peer-to-peer domain 208 may include more than two logical entities 202, 204.

Placing two or more logical entities 202, 204 in a peer-to-peer domain 208 typically provides higher availability of resources available from the logical entities 202, 204. If one entity fails 202, 204 the other continues operating. However, as discussed above, conventional management of the logical entities 202, 204 may be challenging if a management node 216 were required to individually connect to, and manage each logical entity 202, 204.

In the present invention, the peer-to-peer domain 208 grouping ensures that both I/O operations and management operations performed by one entity 202, 204 are mirrored on the other entity 202, 204. In certain embodiments, the first member of the peer-to-peer domain 208 (i.e., first one to come online) becomes the peer leader. The management node 216 may communicate 218 management commands to any member of the peer-to-peer domain 208 or directly to the peer leader. If the entity 202, 204 is not the peer leader, the command may be forwarded to the peer leader. The peer leader interprets the command. If applicable to all members of the peer-to-peer domain 208, the command is mirrored among all members. In this manner a single management command may be issued to a single entity 202, 204 of a peer-to-peer domain 208 and the change is made to all members of the peer-to-peer domain 208. Likewise, the second peer-to-peer domain 210 operates in similar fashion.

Organizing entities 202, 204 into peer-to-peer domains 208 allows an administrator to group like entities, such as storage entities that serve as redundant automatic backups for each other. While a management node 216 can communicate 218 with each entity 20, 204 as needed, the management node 216 can also direct a single management command to the peer-to-peer domain 208 as a single entity 208. In this manner, the management burden/overhead is reduced.

The management node 216 is a physical or logical computing device that monitors and manages the operations of one or more entities 202, 204, 212, 214. Preferably, the management node 216 uses out-of-band communication channels 218 to interact with and monitor entities 202, 204, 212, 214. Entities 202, 204, 212, 214 in communication 218 with the management node 216 define a management domain 220.

A management domain 220 comprises at least one management node 216 and at least one managed entity. The management node 216 sends management commands such as a status inquiry or configuration change to the managed entities 202, 204, 212, 214.

Certain monitoring and management commands require that the management node 216 have access to resources 222, 223 defined for each entity 202, 204. As used herein, “resource” refers to firmware, software, hardware, and logical entities physically allocated to, or logically defined for, a logical entity 202, 204, 212, 214. Examples of resources include physical and logical storage devices, storage device controllers, I/O devices, I/O device drivers, memory devices, memory controllers, processors, symmetric multiprocessor controllers, firmware devices, firmware executable code, operating systems, applications, processes, threads, operating system services, and the like.

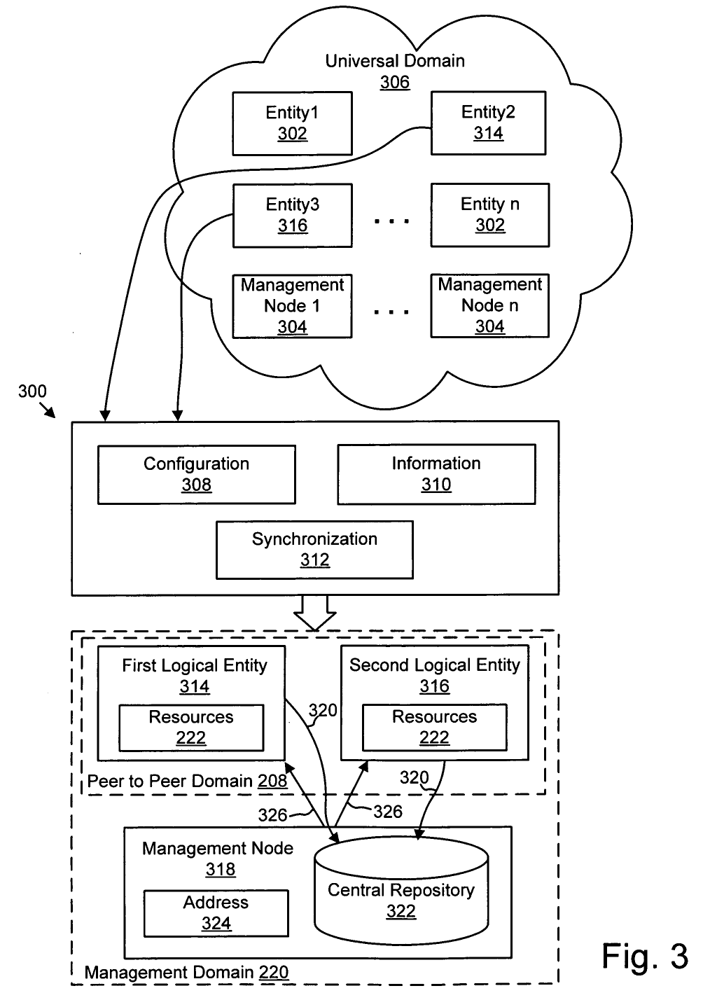

The resources 222, 223 of each entity 202, 204 in a peer-to-peer domain 208 may be the same. Alternatively, resources 222, 223 across all entities 202, 204, 212, 214 regardless of the domain 208, 210 may be the same or different. As explained in more detail in relation to FIG. 3, the present invention exposes the resources 222, 223 of all entities 202, 204, 212, 214 in a management domain 220. The management node 216 uses information about the resources 222, 223 to target management commands to a particular resource 222, 223, also referred to as a target resource 222, 223. Typically, a target resource is the subject of the management command and may include a whole entity 202.

FIG. 2 illustrates one potential arrangement of entities 202, 204, 212, 214 in to peer-to-peer domains 208, 210 in a management domain 220. Of course other configurations are possible. For example, the third logical entity 212 may be placed within the peer-to-peer domain 208 and have a direct peer-to-peer relationship 206 with the first entity 202 and second entity 204. Grouping entities into peer-to-peer domains 208, 210 within a management domain 220 permits pairs of homogeneous logical entities 202, 204 to be managed as a single entity (peer-to-peer domain 208). Furthermore, an organization can group the entities 202, 204 according to various factors including the purpose, function, or geographic location of the entities 202, 204. Peer-to-peer domains 208, 210 can be separated for security and privacy purposes but still managed through a single management node 216.

In one embodiment, the first entity 202 and second entity 204 comprise a first set of logical entities 202, 204 in a peer-to-peer relationship 206 of a first peer-to-peer domain 208. A third entity 212 and fourth entity 214 comprise a second set of logical entities 212, 214 in a peer-to-peer relationship 206 of a second peer-to-peer domain 210. Preferably, there is no communication between the first set of logical entities 202, 204 and the second set of logical entities 212, 214. Together the first set of logical entities 202, 204, the second set of logical entities 212, 214, and the management node 216 form a management domain 220. The resources 222, 223 of the first set of logical entities 202, 204 and the second set of logical entities 212, 214 are exposed to the management node 216 such that the management node 216 can send management commands targeted at the resources 222, 223 of either set.

In this manner, the first set of logical entities 202, 204 and the second set of logical entities 212, 214 are isolated from each other. However, the management node 216 can send management commands to one of the sets as a single entity, to an individual entity, or to both sets together. Such an organization provides flexibility, particularly because a set of two or more entities can be managed as a single unit. As explained above, management commands sent to the peer leader of a set are appropriately routed to the related entity(s) of the set as necessary. The management node 216 may send commands to the first set, the second set, or both the first set and second set.

For example, if a service procedure is required on the second set of logical entities 212, 214, the management node 216 may issue a single quiesce storage command that processes queued I/O and stops any further I/O communication processing on both logical entities 212, 214 automatically. The service procedure may then include additional management commands such as taking the logical entities 212, 214 offline (again using a single command), and the like.

As described above, redundancy of physical and logical entities of a system provide high availability, reliability, and serviceability for a computing system. One redundant entity can be unavailable and the other available such that users of redundant resources 222, 223 continue to use the resources 222, 223 without noticing the unavailable entity.

In one embodiment, a redundant management node 224 mirrors the operations of the management node 216. The management nodes 216, 224 may interact in a peer-to-peer relationship 206. Together the management nodes 216, 224 form a management peer-to-peer domain 226 that allows either management node 216, 224 to monitor and take over management operations for the plurality of peer-to-peer domains 208, 210 in response to failure of one of the management nodes 216, 224. A management peer-to-peer domain 226 includes only management nodes 216, 224 and allows the management nodes 216, 224 to monitor each other and implement take over procedures as necessary. In this manner, redundant management may be provided to further improve the reliability, serviceability, and availability of a system.

FIG. 3 illustrates one embodiment of an apparatus 300 for facilitating storage management. The apparatus 300 enables computer system administrators to apply organization and order to an otherwise disorganized plurality of entities 302 and management nodes 304 defined in a universal domain 306. Depending on the needs and physical hardware of an organization, the number of entities in the universal domain 306 may range between two and several hundred. Identifying entities 302, or resources 222, 223 thereof, as the destination or target of management commands may be difficult without some form of organization. The problem is further complicated if an organization desires to implement redundant homogeneous entities. The apparatus 300 of the present invention implements some order and organization and enforces certain rules regarding inter-entity communication to facilitate and automate management, especially for entities that are intended to mirror and backup each other. Consequently, fewer duplicative management commands addressed to different logical entities are needed. In addition, the order and organization facilitates distinguishing between two or more similarly configured entities 302.

The apparatus 300 may include a configuration module 308, an information module 310, and a synchronization module 312. The configuration module 308 configures a first logical entity 314 to interact with a second logical entity 316 in a peer-to-peer domain 208. The first logical entity 314 is in direct communication with and mirrors the operations of the second logical entity 316. In other words, the first logical entity 314 and the second logical entity 316 have a peer-to-peer relationship 206.

In a peer-to-peer domain 208 of one embodiment, the logical entities 314, 316 have substantially equal rights to monitor and manage each other. This allows for either logical entity 314, 316 to serve as a peer leader and pass management commands to the other logical entity 314. Consequently, as with the redundancy provided in the different systems and subsystems of the present invention, there is no single point of failure. Preferably, each component has a redundant corresponding component such that high availability is provided.

In one embodiment, the logical entities 314, 316 comprise Logical Partitions (LPARs) of a computer system with each LPAR allocated an independent set of computer hardware (processors, memory, I/O, storage). The peer-to-peer domain 208 may include a pair of LPARs such that redundancy is provided.

In one embodiment, the configuration module 308 defines logic controlling communications and mirroring of the logical entities 314, 316 such that each logical entity only mirrors and manages the operations of other logical entities 314, 316 in the peer-to-peer domain 208. For example, one logical entity 314, 316 may be designated the peer leader. All management commands sent to the peer-to-peer domain 208 are routed through the peer leader. The management commands and I/O communications may be mirrored to each logical entity 314, 316 as necessary.

The information module 310 exposes local resources 222 of the first logical entity 314 and the second logical entity 316 to a management node 318. In one embodiment, the information module 310 broadcasts the information defining the local resources 222 to each management node 318 in the management domain 220 using a predetermined communications address for each management node 318. The information module 310 may broadcast initial information defining the local resources 222 as well as modifications made to the information defining the local resources 222. Each management node 318 may receive the information and associate the information with an identifier of the appropriate entity 314, 316.

Alternatively, the information module 310 registers 320 the local resources 222 for the logical entities 314, 316 in a central repository 322. The information module 310 may register initial information. The logical entity may then register updates to the information as needed. The central repository 322 of target resources 222 may comprise a database in which target resources 222 are associated with the appropriate logical entity 314, 316. Alternatively, the central repository 322 may comprise files or any other data structure that associates the local resources 222 with a logical entity 314, 316 and is accessible to the management node(s) 318.

In certain embodiments, the management node 318 manages the logical entities 314, 316 using an object-oriented framework in which management nodes and logical entities are represented by software objects that include both attributes and methods. The attributes store data about the object. The methods comprise logic configured specifically to implement certain functionality for the object. The object-oriented framework may control access to information about resources 222. For example, if the management node 318 is an authorized manager, the software object representing the entities 314, 316 may permit accessor methods to report information regarding local resources. In other words, information that normally would constitute private attributes and/or methods for an object may be made available to the software object representing the management node 318.

The synchronization module 312 synchronizes resource definitions that represent the local resources 222. The resource definitions may be stored in the central repository 322. The synchronization module 312 synchronizes resource definitions after modifications are made to the local resources 222 by the logical entities 314, 316 or directly by a management node 318. Modifications may include configuration changes, updated version information, defining or deleting of resources 222, and the like. In certain embodiments, the synchronization module 312 and/or portions thereof may reside on the logical entities 314, 316 and/or the management node 318.

In one embodiment, the apparatus 300 includes an address module 324 that resides on the management node 318. In certain embodiments, the address module 324 and/or portions thereof may reside on the logical entities 314, 316 and/or the management node 318. The address module 324 selectively addresses a management command from the management node 318 to a local resource 222 of the logical entities 314, 316. As described above and used herein, local resources 222 may represent various physical and logical components associated with a logical entity 314, 316 as well as the entities 314, 316 themselves. For example, local resources 222 may comprise a hierarchy of resources having the logical entity as the root and various logical and physical objects as the descendents.

Which local resource 222 is addressed depends on the nature of the management command and the intended affect. For example, suppose a global change in a peer-to-peer domain 208 is to be made such as allocating an additional one megabyte of memory to a logical memory device “D” of each logical entity 314, 316. The management command may not be addressable to logical entities 314, 316 directly. Instead, the logical memory device “D” of each logical entity 314, 316 may need to receive the management command. Conventionally, a separate command would be sent to the logical memory device “D” of each logical entity 314, 316. However, because the logical entities 314, 316 are in a common peer-to-peer domain 208 and each have a logical memory device “D”, the management node 318 sends a single management command addressed to the logical memory device “D” to the peer leader. The peer leader than relays the management command to the other peer(s) in the peer-to-peer domain 208.

Those of skill in the art will recognize various addressing techniques that may be used to send management commands that are targeted to particular resources 222. For example, resources 222 may be registered with a unique identifier comprising a unique identifier for the resource 222, the logical entity 316, and the peer-to-peer domain 208. As used herein references to targeting a particular resource or targeted resources means both that the management command acts on that particular resource 222 and that the resource 222 may be listed as an argument for executing a management command. In either instance the management node 318 should be able to reference accurately information defining the resource 222.

In one embodiment, the address module 324 uses object-oriented messaging to address a management command to a target resource 222. The address module 324 may maintain a listing of peer domains 208. The address module 324 may also maintain an association between members of peer domains 208 and members of a management domain 220 such that management commands such as a specific hardware command to specific logical entities 314 can be performed.

The address module 324 may utilize an object-oriented framework to send management commands to a desired logical entity 314, 316 and/or local resource 222. In particular, the peer-to-peer domain 208 may be represented by a software object that is uniquely identified by a unique name/identifier in the object-oriented framework. By referencing the association of logical entities to domains 208, the address module 324 may directly reference a software object representing a logical entity 314. The object-oriented framework then relays a targeted management command to a particular logical entity 314 and/or local resource 222. This is but one example of how the management node 318 may target a local resource 222.

The first logical entity 314 and second logical entity 316 have a management relationship 326 with the management node 318. A management relationship 326 permits the management node 318 to monitor and manage (through management commands) the operations of the entities 314, 316. The entities 314, 316 however are unable to manage or monitor the management node 318 (hence the one-way arrows representative of management authority). The management node 318 and peer-to-peer domain 208 that includes the entities 314, 316 together comprise the management domain 220.

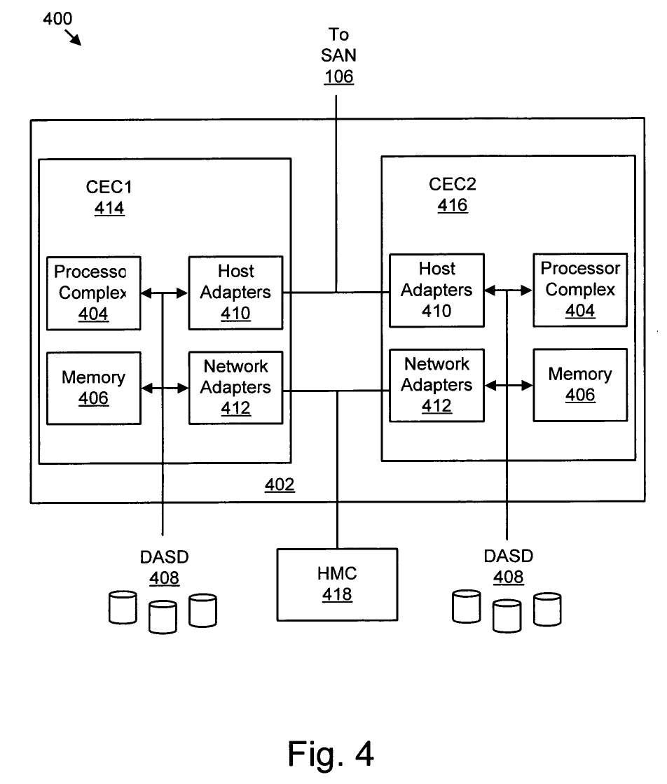

FIG. 4 illustrates system hardware suitable for implementing a system 400 to facilitate storage management. As noted above, data processing systems continue to become more complicated as less expensive hardware is combined into a single physical enclosure. The hardware is then partitioned out either physically, logically, or with a combination of physical and logical partitioning into a plurality of logical entities 202, 204 (See FIG. 2). Using duplicate hardware allows for higher availability by including redundant subcomponents such as logical entities 202, 204.

In one embodiment suitable for use as a storage subsystem, the system 400 includes at least two physically separate Central Electronic Complexes (CECs) joined by a common hardware platform 402. The common hardware platform 402 may comprise a simple physical enclosure.

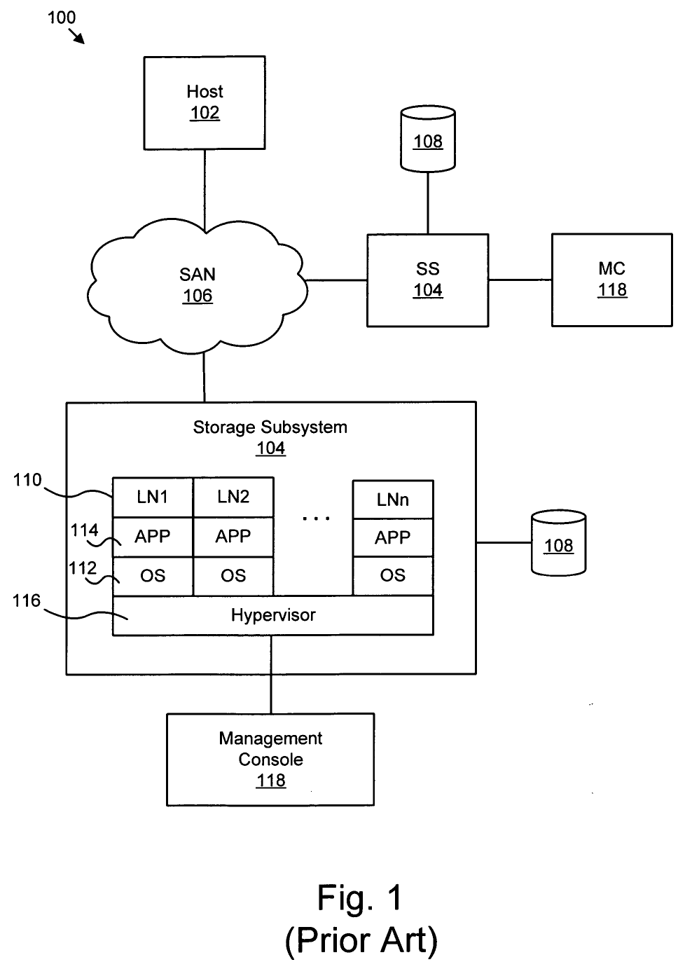

A CEC is an independent collection of physical computing devices connected to a common coordination module 116, such as a PHYP 116 (See FIG. 1). A CEC includes a plurality of symmetric multiprocessors organized in a processor complex 404, a plurality of electronic memory devices 406, a plurality of Direct Access Storage Devices (DASD) 408, a plurality of network I/O interface devices 410, such as host adapters 410, and a plurality of management interface devices 412, such as network adapters 412. The CEC may include an independent power coupling and power infrastructure as well as a ventilation and cooling system. Each CEC can be power cycled independently. Even certain subsystems can be power cycled without affecting performance of other parts of the CEC. Of course those of skill in the art will recognize that certain hardware devices described above may be organized into subsystems and include various controllers not relevant to the present invention but that enable the CEC to support a plurality of logical nodes 206.

In one embodiment, the system 400 includes a first CEC 414 and a second CEC 416. Preferably, the second CEC 416 includes substantially the same quantity, type, brand, and configuration of hardware as the first CEC 414. Having common hardware reduces the variables involved in troubleshooting is a problem occurs. In one embodiment, the first CEC 414 and second CEC 416 may be managed and controlled by a single Hardware Management Console (HMC) 418 connected via the network adapters 412. In one embodiment, the HMC 418 is a dedicated hardware management device such as a personal computer running a LINUX operating system and suitable management applications.

It should be noted that managing such a complex system 400 of hardware, even within a single CEC can be very challenging. Especially, if a goal of 24/7 availability is to be maintained. Consequently, the HMC 418 includes complex service and maintenance scripts and routines to guide administrators in servicing a CEC such that the highest level of availability can be maintained. A single mistake can have dramatic consequences. In certain embodiments, the management logic is embodied in a plurality of resource managers. The various resource managers monitor and check the health of the various hardware and software subsystems of the ESS. Software modules and scripts coach service technicians and systems administrators in diagnosing and fixing problems as well as performing preventative maintenance. Typically, these routines properly shutdown (power cycle) subcomponents and/or systems while the remaining hardware components remain online.

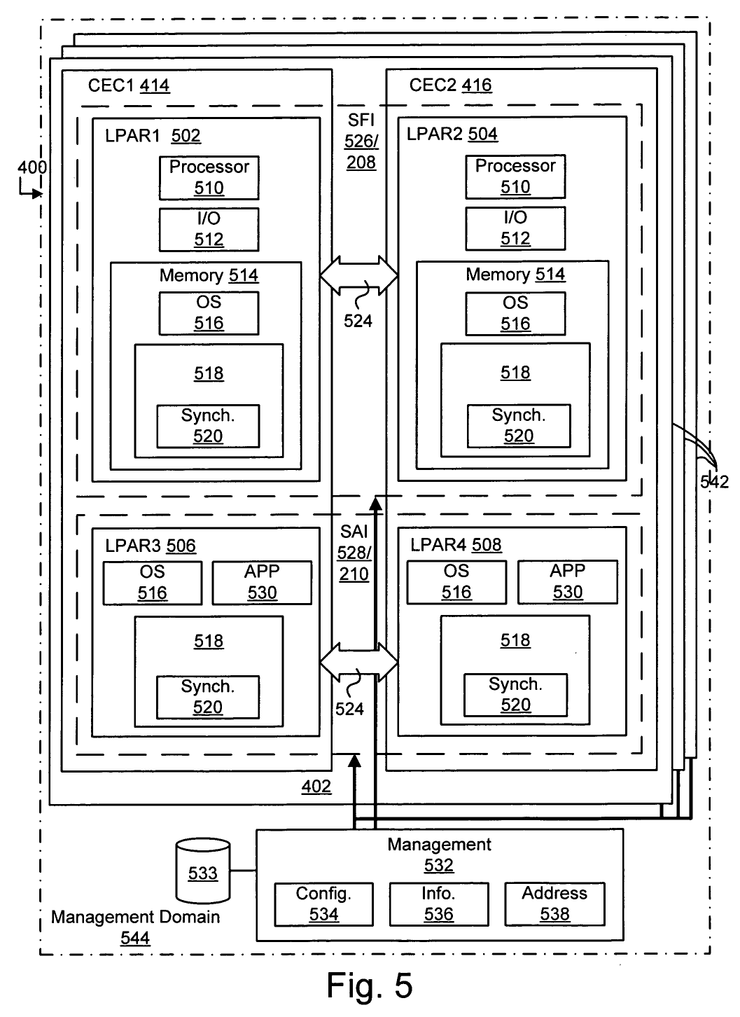

FIG. 5 illustrates the hardware system 400 of FIG. 4 and includes the software and logical entities that operate on the hardware. The system 400 includes a first CEC 414 and a second CEC 416 within the common hardware platform 402. In one embodiment, the CECs 414, 416 are completely independent and operate within a storage subsystem.

The system 400 includes a first Logical Partition (LPAR) 502, second LPAR 504, third LPAR 506, and fourth LPAR 508. Certain systems 400 may comprise more LPARs than those illustrated. Each LPAR 502-508 comprises an allocation of computing resources including one or more processors 510, one or more I/O channels 512, and persistent and/or nonpersistent memory 514. Certain computing hardware may be shared and other hardware may be solely dedicated to a particular LPAR. As used herein, LPAR refers to management and allocation of one or more processors, memory, and I/O communications such that each LPAR is capable of executing an operating system independent of the other LPARs. Other terms commonly used to describe LPARs include virtual machines and logical entities 202, 204 (See FIG. 2).

In one embodiment, the first LPAR 502 and second LPAR 504 are homogeneous such that the configuration of the processors 510, 1O 512, and memory 514 is identical. Similarly, the software executing in the memory 514 may be homogeneous. The respective LPAR 502, 504 memory 514 may execute the same OS 516 and a resource manager 518.

Preferably, the resource manager 518 comprises logic for handling management commands to the specific LPAR 502, 504. The resource manager 518 may include a synchronization module 520. The synchronization module 520 may comprise substantially the same logic as the synchronization module 312 described in relation to FIG. 3.

In one embodiment, the first LPAR 502 operating on a first CEC 414 operates in a peer-to-peer relationship 524 with a second LPAR 504 operating on a second CEC 416. Together the first LPAR 502 and second LPAR 504 define a Storage Facility Image (SFI) 526. Preferably, the SFI 526 substantially corresponds to the grouping, features, and functionality of a peer-to-peer domain 208 described in relation to FIG. 2. In certain embodiments, a SFI 526 may comprise a subset of a peer-to-peer domain 208 because where a peer-to-peer domain 208 may have two or more LPARs 502, 504, an SFI 526 may be limited in one embodiment to two LPARs 502, 504.

The SFI 526 provides a redundant logical resource for storage and retrieval of data. All data storage processing is typically logically split between LPAR 502 and LPAR 504, when one LPAR is not available the remaining LPAR processes all work. Preferably, the SFI 526 includes one LPAR 502 operating on physical hardware that is completely independent of the physical hardware of the second LPAR 504. Consequently, in preferred embodiments, the SFI 526 comprises a physical partitioning of hardware. In this manner, one CEC 416 may be off-line or physically powered off and the SFI 526 may remain on-line. Once the CEC 416 returns on-line, the resource managers 518 may synchronize the memory 514 and storage such that the second LPAR 504 again matches the first LPAR 502.

The SFI 526 may be further divided into logical storage devices. The SFI 526 may also include virtualization driver software for managing logical storage devices. Preferably, the SFI 526 includes just the necessary software to store and retrieve data. For example, one SFI 526 may comprise a file system in the OS that permits storage and retrieval of data.

The system 400 may also include a Storage Application Image (SAT) 528 comprised of the third LPAR 506 and the fourth LPAR 508 in a peer-to-peer relationship 524. Preferably, the LPARs 506, 508 defining a SAI 528 include the same OS 516 and same resource manager 518. In certain embodiments, the OS 516 and/or resource manager 518 of an SFI 526 may differ from the OS 516 and/or resource manager 518 of the SAI 528. In certain embodiments, the SAI 528 substantially corresponds to the grouping, features, and functionality of a peer-to-peer domain 208 described in relation to FIG. 2. In certain embodiments, a SAI 528 may comprise a subset of a peer-to-peer domain 208 because where a peer-to-peer domain 208 may have two or more LPARs 502, 504, an SAI 528 may be limited in one embodiment to two LPARs 502, 504.

Preferably, peer-to-peer domains 208, 210 are kept separate from each other. If a peer-to-peer relationship is desired between members of multiple peer-to-peer domains 208, 210, the multiple peer-to-peer domains 208, 210 are combined to form a single peer-to-peer domain 208. Consequently, two SFIs 526 and/or SAIs 528 would not be in a peer-to-peer domain 208 with each other. This may be beneficial because in a storage context storage facility images serve a different purpose from storage application images. In other words, there may be little or no relationship between I/O and management operations performed on an SFI 526 and on an SAI 528.

The SAI 528 organizes storage applications into a single logical unit that can be managed independently of the logical and physical storage devices 408 (See FIG. 4) of the SFI 526. The SAI 528 also includes redundancy as the third LPAR 506 and fourth LPAR 508 mirror the data processing on each other. Preferably, the SFI 526 includes the third LPAR 506 operating on physical hardware that is completely independent of the physical hardware of the fourth LPAR 508. Consequently, in preferred embodiments, the SAI 528 comprises a physical partitioning of hardware. In this manner, one CEC 416 may be off-line or physically powered off and the SAI 528 may remain on-line. The storage applications 530 of the SAI 528 comprise applications specifically for managing storage and retrieval of data. Examples of storage applications include the Tivoli Storage Manager from IBM, a database management system, and the like.

A management module 532 is configured to selectively communicate management commands to the SFI 526 and/or SAI 528 (peer-to-peer domains). Alternatively or in addition, the management module 532 may send management commands directly to individual LPARS 502-508 as needed. The exposed local resources 533 of the LPARs 502-508 allow the management module 532 to send management commands to specific resources 533 and/or include specific resources 533 arguments in certain management commands.

The management module 532 includes a configuration module 534, information module 536, and address module 538 that include substantially the same functionality as the configuration module 308, information module 310, and address module 324 described in relation to FIG. 3. Specifically, the information module 536, or components thereof, may broadcast information defining local resources 533 of the SFI 526 and/or SAI 528. Alternatively, the information module 536, or components thereof, may register information defining local resources 533 of the SFI 526 and/or SAI 528 in a central repository such as a database accessible to the management module 532.

In certain embodiments, the information module 536 retrieves information defining local resources from the LPARs 502-508 through periodic polling. Alternatively, the information module 536 may retrieve information defining local resources based on a signal from the LPARs 502-508. Beneficially, the management module 532 abstracts the detail of multiple LPARS 502, 504 representing a single SFI 526 and allows a user to address management commands to the whole SFI 526 with assurance that specific changes to each LPAR 502, 504 will be made.

Preferably, management module 532 communicates management commands to the SFIs 526 and SAIs 528 and thus to the LPARs 502-508 through a management subsystem 540 that logically links the management module 532 and the LPARs 502-508. One example of a subsystem that may be modified in accordance with the present invention is a Resource Monitoring and Control (RMC) subsystem available from International Business Machines Corporation (IBM) of Armonk, N.Y. Those of skill in the art will recognize that a management subsystem 540 that supports the present invention is not the same as a conventional RMC subsystem from which it originates.

The RMC-based management subsystem 540 is a functional module that is typically incorporated in an operating system such as AIX. Of course, the management subsystem 540 may be implemented in other operating systems including LINUX, U Windows, and the like. Complimentary components of the management subsystem 540 may reside on both the management module 532 and the LPARs 502-508.

The management subsystem monitors 540 resources such as disk space, processor usage, device drivers, adapter card status, and the like. The management subsystem 540 is designed to perform an action in response to a predefined condition. However, a conventional RMC is unable to interface concurrently with a pair of LPARs 502-508 in a peer-to-peer domain 208 (SFI 526 or SAI 528). Instead, conventional RMC subsystems communicate with one LPAR at a time.

In certain embodiments of the present invention, the conventional RMC subsystem is extended and modified to create a modified management subsystem 540 capable of permitting management and monitoring within a peer-to-peer domain 208 and preventing LPARs from managing or monitoring LPARs in another peer-to-peer domain 208. The modified management subsystem 540 may also allow a management node, such as management module 532, to manage two or more peer-to-peer domains 208, 210.

The modified management subsystem 540 may include an object model that comprises objects representing each manageable resource of the one or more LPARs 502-508. An object is representative of the features and attributes of physical and logical resources. The object may store information such as communication addresses, version information, feature information, compatibility information, operating status information, and the like.

The management subsystem 540 further includes a set of resource managers 518. The resource managers 518 in one embodiment comprise the logic that interprets and applies management commands to resources 533 that are defined in the object model. In certain embodiments, the resource managers 518 are software extensions of existing RMC modules executing on each LPAR 502-508. The resource managers 518 may extend object-oriented RMC modules or procedurally designed RMC modules.

In certain embodiments, the management module 532 serves as the central point of management for a plurality of SFIs 526, SAIs 528, and the associated LPARs 502-508 defined therein. The management module 532 may be coupled through an out-of-band communication network to a plurality of hardware platforms 542. The management module 532 is preferably configured to send one or more management commands to the SFIs 526 and SAIs 528 distributed across a plurality of platforms 542. Furthermore, each SFI 526 and/or SAI 528 may comprise a different OS 516 and/or set of applications 530. The SFIs 526 and/or SAIs 528 may be organized into a common management domain 544 according to geography, or a common purpose, functionality, or other characteristic. It should be noted that the management domain 544 may include a plurality of hardware platforms 542. The management module 532 may allow commands to be issued to select peer-to-peer domains 208, 210 comprising an SFI 526, an SAI 528, or a combination of SFIs 526 and SAIs 528.

Referring still to FIG. 5, the management subsystem 540 and resource managers 518 are preferably configured such that a first LPAR 502 will take over operations of the second LPAR 504 and vice versa in response to failure of one of the LPARs 502, 504. The peer-to-peer domain 208 makes this possible by providing a communication channel such that each LPAR 502, 504 mirrors operations of the other. In certain embodiments, when one LPAR 502, 504 of a peer-to-peer domain 208 fails, the management subsystem 540 may log a set of changes made on the nonfailing LPAR since the failed LPAR went offline. In addition, the management subsystem 540 may assist the resource manager 518 of the active LPAR in restoring the set of changes once the failed LPAR comes back online.

The peer-to-peer domain 208 allows each LPAR 502, 504 to monitor the other. Consequently, the LPARs 502, 504 may include logic that detects when the other LPAR has an error condition such as going offline. Once an error condition is detected logging may be initiated. The same monitor may signal when the LPAR comes back online and trigger restoration of the set of changes. In this manner, real-time redundancy is provided such that the peer-to-peer domain 208 as a whole (or an SFI 526 or SAI 528) remains available to the host 102.

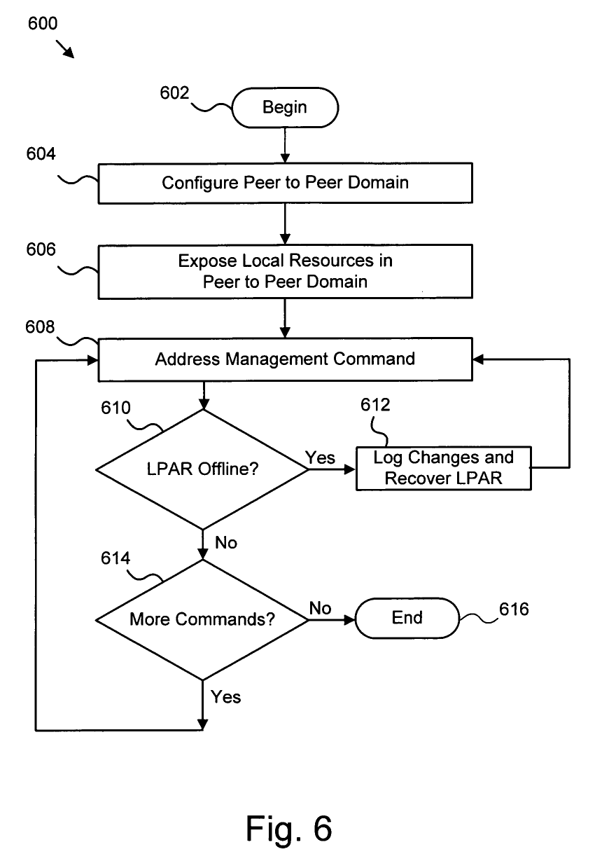

FIG. 6 illustrates a flow chart of a method 600 for facilitating storage through organization of storage resources according to one embodiment. The method 600 begins 602 once an administrator desires to organize logical entities 202, 204, 212, 214 and management nodes 216, 224 into one or more peer-to-peer domains 208, 210 within a management domain 220 (See FIG. 2). For example, an administrator may organize pairs of LPARs into peer-to-peer domains 208 such as an SFI 526 so that one LPAR is a redundant active backup for the other LPAR. In addition, the administrator may desire to control and manage a plurality of SFIs 526 across multiple hardware platforms 542 from a single management node 216. Organizing one or more peer-to-peer domains 208, 210 within a management domain 220 allows resources of the peer-to-peer domains 208, 210, or LPARs within the peer-to-peer domains 208, to be addressed with a single management command.

Initially, an administrator configures 604 two or more logical entities 202, 204 into a peer-to-peer domain 208 such that each logical entity 202, 204 mirrors operations of the other. Typically, this means that certain communication channels and protocols are established between the two or more logical entities 202, 204 such that each logical entity 202, 204 has a direct communication with every other logical entity 202, 204 in the peer-to-peer domain 208. Preferably, dedicated management channels are used to logically link the logical entities 202, 204.

Next, the information module 310 exposes 606 the local resources 222 of each logical entity 314, 314 within one or more peer-to-peer domains 208, 210 of a single management domain 220. As discussed above, there are a variety of techniques that may be used to inform the management node 318 about the local resources 222 such that local resources 222 can be used as target resources 322 in management commands. In addition, the information module 310 in cooperation with other management subsystems may maintain the target resources 322 as local resources 222 are updated and modified.

Then, as management commands are issued by the management node 318, an address module 324 selectively addresses 608 management commands towards local resources 222 associated with a peer-to-peer domain 208. Alternatively, the address module 324 addresses 608 a management command to a first logical entity 314 or a second logical entity 316 of a peer-to-peer domain 208. Which resource 222 a management command is directed towards depends, in part, on the type of management command. Higher level (meaning not related to hardware devices) management commands may be sent to a pair of resources 222 common between the entities 314, 316. Lower level (meaning related to hardware devices) management commands may be sent to a specific resource 222 of a specific entity 314, 316. Various addressing techniques may be used.

Next, a determination 610 is made whether a logical entity 314 or LPAR 502 is offline. An LPAR 502 may be affirmatively taken offline for service or troubleshooting or an LPAR 502 may involuntarily go offline due to an error condition. If the LPAR 502 is offline, the logic (i.e., a logging module executing on the entity 314, 316) defining the peer-to-peer domain 208 may begin logging 612 a set of changes made to one or more online LPARs 504 of the peer-to-peer domain 208. Once the offline LPAR 502 comes back online, the logic may restore the LPAR 502 by applying the set of logged changes to the LPAR 502. Typically, the LPAR 504 that remained online performs the application of updates to the restored LPAR 502.

If none of the logical entities 314, 316 or LPARs 502, 504 are offline, a determination 614 is made whether more management commands are pending for the logical entities 314, 316 of the management domain 220. If so, the method 600 returns to address 608 the next management command. If not, the method 600 ends 616.

Those of skill in the art will quickly recognize the potential benefits provided by the present invention. The ability to manage SFIs 526 and SAIs 528 (whole peer-to-peer domains 208) individually and/or individual LPARs 502-508 saves the administrator significant time and significantly reduces the potential for errors and mistakes. In addition, a plurality of management nodes 216, 224 may be related in a management peer to peer domain 226. Like the logical entities 202, the management nodes 216, 224 may monitor and manage each other such that should one fail the other may continue implementing a set of management commands where the failed management node 216 left off. Thus, the present invention provides advancements in managing logical entities that may be related to form SFIs 526 and SAIs 528. The present invention provide redundancy at the LPAR level and the management node level. Finally, the present invention eases the administrative burden for logical entities that are typically similarly configured for redundancy purposes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

What is claimed is:

1. An apparatus to facilitate storage management, the apparatus comprising:
a configuration module that configures a first logical entity and a second logical entity to interact with each other in a peer-to-peer domain such that each logical entity mirrors operations of, and is in direct communication with, the other logical entity;
an information module configured to expose local resources of the first logical entity and local resources of the second logical entity to a management node such that the local resources of the first logical entity and the second logical entity are available as target resources of a management command from the management node; and
an address module configured to selectively address a management command from the management node towards a local resource of the first logical entity and a local resource of the second logical entity.

2. The apparatus of claim 1, wherein the configuration module is designed to configure the management node to interact with the first logical entity and the second logical entity in a management relationship that defines a management domain.

3. The apparatus of claim 2, wherein the management domain comprises the management node and at least one logical entity, the at least one logical entity configured to be managed and monitored by the management node and incapable of managing or monitoring the management node.

4. The apparatus of claim 2, wherein the management domain comprises three or more logical entities in a peer-to-peer domain with each other, the local resources of each logical entity exposed to the management node for use as target resources of a management command from the management node.

5. The apparatus of claim 2, wherein the management domain comprises a first set of logical entities in a peer-to-peer domain with each other and a second set of logical entities in a peer-to-peer domain with each other, the local resources of each logical entity exposed to the management node for use as target resources of a management command, the logical entities of the one set unable to communicate with logical entities of the other set.

6. The apparatus of claim 5, wherein the address module is further configured to target a management command directly to the first set.

7. The apparatus of claim 5, wherein the address module is further configured to target a management command directly to the first set and the second set.

8. The apparatus of claim 1, wherein the management domain further comprises a second management node configured to interact with the management node in a management peer-to-peer domain that allows either management node to monitor and take over management operations in response to a failure of one of the management nodes.

9. The apparatus of claim 1, wherein the peer-to-peer domain comprises at least two logical nodes configured with substantially equal rights to monitor and manage each other.

10. The apparatus of claim 1, wherein the first logical entity and second logical entity of the peer-to-peer domain are configured to take over operations of the other logical entity in response to failure of one of the logical entities, log a set of changes since the failed logical entity went offline, and restore the set of changes in response to the failed logical entity coming online.

11. The apparatus of claim 1, wherein the information module is further configured to broadcast the local resources of the first logical entity and local resources of the second logical entity to the management node.

12. The apparatus of claim 1, wherein the information module is further configured to register the local resources of the first logical entity and local resources of the second logical entity in a central repository accessible to the management node.

13. The apparatus of claim 1, further comprising a synchronization module configured to synchronize resource definitions representative of the local resources of the first logical entity and the second logical entity in response to modifications made to the local resources by the first logical entity or the second logical entity.

14. The apparatus of claim 1, wherein the management node sends management commands over a communications channel separate from one or more Input/Output (I/O) channels used by the first logical entity and second logical entity.

15. The apparatus of claim 1, wherein the first logical entity and second logical entity comprise Logical Partitions (LPARS) of a common hardware platform, the LPARS configured such that each LPAR executes on a separate Central Electronics Complex (CEC) of the common hardware platform.

16. The apparatus of claim 1, wherein the first logical entity and second logical entity define an independently manageable Storage Facility Image (SFI) and wherein the address module is further configured to send the management command to a plurality of SFIs within a management domain.

17. An apparatus to facilitate storage management, the apparatus comprising:
a configuration module that configures a first Logical Partition (LPAR) and a second LPAR to interact with each other in a peer-to-peer domain such that each LPAR mirrors operations of, and is in direct communication with, the other LPAR;
an information module configured to expose local resource definitions of the first LPAR and local resource definitions of the second LPAR to a management node such that the local resources of the first LPAR and the second LPAR are available as target resources of a management command from the management node; and
an address module configured to selectively address a management command from the management node towards a local resource of the first LPAR and a local resource of the second LPAR.

18. The apparatus of claim 17, wherein the first LPAR and second LPAR define an independently manageable Storage Facility Image (SFI) and wherein the address module is further configured to send the management command to a plurality of SFIs within a management domain.

19. The apparatus of claim 17, wherein the information module is further configured to register the local resources of the first LPAR and local resources of the second LPAR in a central repository accessible to the management node.

20. The apparatus of claim 17, further comprising a synchronization module configured to synchronize resource definitions representative of the local resources of the first LPAR and the second LPAR in response to modifications made to the local resources by the first LPAR or the second LPAR.

21. A system to facilitate storage management, the system comprising:
a first Central Electronics Complex (CEC) operatively coupled to a hardware platform, the first CEC comprising a plurality of symmetric multiprocessors organized into a first processor complex, a plurality of electronic memory devices, a plurality of direct access storage devices, a plurality of network Input/Output (I/O) interface devices, and a plurality of management interface devices, each of the devices of the CEC electronically coupled for exchange of data and control information;
a second CEC operatively coupled to the hardware platform, the second CEC comprising a plurality of symmetric multiprocessors organized into a second processor complex, a plurality of electronic memory devices, a plurality of direct access storage devices, a plurality of network Input/Output (I/O) interface devices, and a plurality of management interface devices, each of the devices of the CEC electronically coupled for exchange of data and control information;
at least one Storage Facility Image (SFI) comprising a first Logical Partition (LPAR) defined to operate using computing resources of the first CEC and a second LPAR defined to operate using computing resources of the second CEC, the first LPAR and second LPAR dedicated to storage and retrieval of data;
at least one Storage Application Image (SAI) comprising a third Logical Partition (LPAR) defined to operate using computing resources of the first CEC and a fourth LPAR defined to operate using computing resources of the second CEC, the third LPAR and fourth LPAR dedicated to data storage applications;
a configuration module that configures the first LPAR and the second LPAR to interact with each other in a peer-to-peer domain such that each LPAR mirrors operations of, and is in direct communication with, the other LPAR and further configure the third LPAR and the fourth LPAR to interact with each other in a peer-to-peer domain such that each LPAR mirrors operations of, and is in direct communication with, the other LPAR;
an information module configured to expose local resource definitions of the at least one SFI and the at least one SAI to a management node such that the local resources of the at least one SFI and the at least one SAI are available as target resources of a management command from the management node; and
an address module configured to selectively address a management command from the management node towards a local resource of the at least one SFI and the at least one SAI.

22. The system of claim 21, further comprising a synchronization module configured to synchronize resource definitions representative of the local resources of the at least one SFI and the at least one SAI in response to modifications made to the local resources of either LPAR of the at least one SFI or the at least one SAI.

23. The system of claim 21, wherein the information module is further configured to broadcast the local resources of the at least one SFI and local resources of the at least one SAI to the management node.

24. The system of claim 21, wherein the information module is further configured to register the local resources of the at least one SFI and local resources of the at least one SAI in a central repository accessible to the management node.

25. A signal bearing medium tangibly embodying a program of machine-readable instructions executable by a digital processing apparatus to perform operations to facilitate storage management, the operations comprising:
an operation to configure a first logical entity and a second logical entity to interact with each other in a peer-to-peer domain such that each logical entity mirrors operations of, and is in direct communication with, the other logical entity;
an operation to expose local resources of the first logical entity and local resources of the second logical entity to a management node such that the local resources of the first logical entity and the second logical entity are available as target resources of a management command from the management node; and
an operation to selectively address a management command from the management node towards a local resource of the first logical entity and a local resource of the second logical entity.

26. The signal bearing medium of claim 25, further comprising configuring the management node to interact with the first logical entity and the second logical entity in a management relationship that defines a management domain.

27. The signal bearing medium of claim 26, wherein the management domain comprises the management node and at least one logical entity, the at least one logical entity configured to be managed and monitored by the management node and incapable of managing or monitoring the management node.

28. The signal bearing medium of claim 26, wherein the management domain comprises three or more logical entities in a peer-to-peer domain with each other, the local resources of each logical entity exposed to the management node for use as target resources of a management command from the management node.

29. The signal bearing medium of claim 26, wherein the management domain comprises a first set of logical entities in a peer-to-peer domain with each other and a second set of logical entities in a peer-to-peer domain with each other, the local resources of each logical entity exposed to the management node for use as target resources of a management command, the logical entities of the one set unable to communicate with logical entities of the other set.

30. The signal bearing medium of claim 29, wherein the operations further comprise an operation to target a management command directly to the first set.

31. The signal bearing medium of claim 29, wherein the operations further comprise an operation to target a management command directly to the first set and the second set.

32. The signal bearing medium of claim 26, wherein the management domain further comprises a second management node configured to interact with the management node in a management peer-to-peer domain that allows either management node to monitor and take over management operations in response to a failure of one of the management nodes.

33. The signal bearing medium of claim 25, wherein the peer-to-peer domain comprises at least two logical nodes configured with substantially equal rights to monitor and manage each other.

34. The signal bearing medium of claim 25, wherein the first logical entity and second logical entity of the peer-to-peer domain are configured to take over operations in response to failure of the other logical entity, log a set of changes since the failed logical entity went offline, and restore the set of changes in response to the failed logical entity coming online.

35. The signal bearing medium of claim 25, wherein exposing further comprises broadcasting the local resources of the first logical entity and local resources of the second logical entity to the management node.

36. The signal bearing medium of claim 25, wherein exposing further comprises registering the local resources of the first logical entity and local resources of the second logical entity in a central repository accessible to the management node.

37. The signal bearing medium of claim 25, further comprising synchronizing resource definitions representative of the local resources of the first logical entity and the second logical entity in response to modifications made to the local resources by the first logical entity or the second logical entity.

38. The signal bearing medium of claim 25, wherein the first logical entity and second logical entity comprise Logical Partitions (LPARS) of a common hardware platform, the LPARS configured such that each LPAR executes on a separate Central Electronics Complex (CEC) of the common hardware platform.

39. A method for facilitating storage management, the method comprising:
configuring a first logical entity and a second logical entity to interact with each other in a peer-to-peer domain such that each logical entity mirrors operations of, and is in direct communication with, the other logical entity;
exposing local resources of the first logical entity and local resources of the second logical entity to a management node such that the local resources of the first logical entity and the second logical entity are available as target resources of a management command from the management node; and
selectively addressing a management command from the management node towards a local resource of the first logical entity and a local resource of the second logical entity.

40. An apparatus for facilitating storage management, the apparatus comprising:
means for configuring a first logical entity and a second logical entity to interact with each other in a peer-to-peer domain such that each logical entity mirrors operations of, and is in direct communication with, the other logical entity;
means for exposing local resources of the first logical entity and local resources of the second logical entity to a management node such that the local resources of the first logical entity and the second logical entity are available as target resources of a management command from the management node; and
means for selectively addressing a management command from the management node towards a local resource of the first logical entity and a local resource of the second logical entity.
